(19) United States
(12) Patent Application Publication
(10) Pub. No.: US 2026/0149920 A1
(43) Pub. Date: May 28, 2026

(54) Array Pickup Method and Apparatus Capable of Steplessly Adjusting Pickup Direction

(71) Applicant: Shenzhen Bajin Technology Co., Ltd., Shenzhen (CN)

(72) Inventor: Shaoqin Ye, Shenzhen (CN)

(21) Appl. No.: 19/010,261

(22) Filed: Jan. 6, 2025

(30) Foreign Application Priority Data
Nov. 26, 2024 (CN) 202411704321.X

(51) Int. Cl. H04R 3/00; H04R 1/40; H04R 3/04; H04R 29/00

(52) U.S. Cl. CPC H04R 3/005; H04R 1/406; H04R 3/04; H04R 29/005; H04R 2410/01; H04R 2430/01

(57) ABSTRACT

The present disclosure discloses an array pickup method and apparatus capable of steplessly adjusting a pickup direction. The method includes: receiving a first audio from a unidirectional mic capsule and a second audio from a nondirectional mic capsule, and performing calculation to obtain a gain coefficient; performing gain processing on the first audio according to the gain coefficient to obtain a first gain audio; performing delay alignment on the second audio to obtain an auxiliary audio; performing sound mixing processing on the first gain audio and the auxiliary audio according to a proportion value to obtain a sound-mixed audio; and performing noise reduction processing on the sound-mixed audio according to a noise reduction strategy and the gain coefficient to obtain a corresponding target audio. A noise reduction function stronger than that of traditional single mic capsule or simple array pickup is achieved.

### CROSS REFERENCES TO RELATED APPLICATION

The present application claims the benefit of Chinese Patent Application No. 202411704321.X filed on Nov. 26, 2024, the contents of which are incorporated herein by reference in their entirety.

### TECHNICAL FIELD

The present disclosure relates to the technical field of audio processing, in particular to an array pickup method and apparatus capable of steplessly adjusting a pickup direction.

### BACKGROUND ART

In order to meet application demands of different pickup directions, there are some professional mikes of which pickup directions can be changed by means of peripheral circuits (for example, the pickup directions can be switched into cardioid pickup or bidirectional pickup), and there are also some mike apparatuses of which the overall output pickup directions can be changed by switching different pickup direction instruments by means of a circuit. As a whole, for all current existing methods and apparatuses for changing a pickup direction of a mike, a certain switching (hardware or software) method is used to select different pickup instruments, and thus, the change of an output direction of the mike is achieved. The method and the apparatus have the disadvantages that 1, the output direction of the mike is limited to the directionality of an original pickup instrument, and in view of the overall volume of the mike, it is generally impossible to integrate more mic capsules with different directions to achieve multi-direction output; 2, the output direction of the mike cannot exceed a direction range of the original pickup instrument: for example, an output of a cardioid and omnidirectional combination can only be cardioid or omnidirectional, but a super-cardioid direction or a bidirectional direction cannot be achieved; 3, the change of the directionality of the mike is discrete switching, the gradual change of the directionality cannot be achieved, and it is difficult to meet a use scenario where the directionality of the mike needs to be finely adjusted; and 4, such a mike only uses a pickup instrument at the same time and does not effectively utilize an array pickup characteristic formed by a plurality of microphones so as to have s poor post-processing noise reduction performance.

For another kind of microphone array based on a differential array, a pickup direction of the array can be adjusted by adjusting delay differential sound mixing proportions of different array elements, but the array is generally achieved by using array elements with uniform directionality (which are usually nondirectional mic capsules), which has the disadvantage that it is difficult to achieve strong directionality when the number of the array elements is smaller. Therefore, there is a problem of poorer pickup directionality existing in a microphone array for pickup in an existing technical method.

### SUMMARY OF THE INVENTION

Embodiments of the present disclosure provide an array pickup method and apparatus capable of steplessly adjusting a pickup direction so as to solve the problem of poorer pickup directionality existing in a microphone array for pickup in an existing technical method.

In a first aspect, an embodiment of the present disclosure provides an array pickup method capable of steplessly adjusting a pickup direction, wherein the method is applied to a pickup controller, the pickup controller is in communication connection with a directionality adjustable pickup array, the directionality adjustable pickup array consists of a unidirectional mic capsule and a nondirectional mic capsule, and the method includes:
if a first audio from the unidirectional mic capsule and a second audio from the nondirectional mic capsule are received, performing calculation according to a preset audio gain strategy to obtain a gain coefficient corresponding to the first audio and the second audio;
performing gain processing on the first audio according to the gain coefficient to obtain a corresponding first gain audio;
performing delay alignment on the second audio according to a preset delay duration to obtain a corresponding auxiliary audio;
performing sound mixing processing on the first gain audio and the auxiliary audio according to a preset proportion value to obtain a corresponding sound-mixed audio; and
performing noise reduction processing on the sound-mixed audio according to a preset noise reduction strategy and the gain coefficient to obtain a corresponding target audio.

In a second aspect, an embodiment of the present disclosure further provides an array pickup apparatus capable of steplessly adjusting a pickup direction, wherein the apparatus includes an apparatus body, a pickup controller and a directionality adjustable pickup array, the pickup controller is used for performing the array pickup method capable of steplessly adjusting the pickup direction in the above-mentioned first aspect;
the pickup controller is disposed in the apparatus body;
the directionality adjustable pickup array consists of a unidirectional mic capsule and a nondirectional mic capsule; the unidirectional mic capsule and the nondirectional mic capsule are both disposed on the same outer surface of the apparatus body; a pickup direction of the unidirectional mic capsule faces away from the nondirectional mic capsule; and
the pickup controller is respectively in communication connection with the unidirectional mic capsule and the nondirectional mic capsule.

Embodiments of the present disclosure provide an array pickup method and apparatus capable of steplessly adjusting a pickup direction. The method includes: receiving and calculating a first audio from a unidirectional mic capsule and a second audio from a nondirectional mic capsule to obtain a gain coefficient; performing gain processing on the first audio according to the gain coefficient to obtain a first gain audio; performing delay alignment on the second audio to obtain an auxiliary audio; performing sound mixing processing on the first gain audio and the auxiliary audio according to a proportion value to obtain a sound-mixed audio; and performing noise reduction processing on the sound-mixed audio according to a noise reduction strategy and the gain coefficient to obtain a corresponding target audio. The above-mentioned method is used in combination with an array pickup apparatus capable of steplessly and gradually adjusting a pickup direction, two or more mic capsules with different pickup directions are utilized to form a pickup array, the wide-range stepless adjustment for pickup directionality is achieved by means of a specific microphone array algorithm, and at the same time, a noise reduction function stronger than that of traditional single mic capsule or simple array pickup is achieved in combination with an array post-processing noise reduction algorithm.

### BRIEF DESCRIPTION OF THE DRAWINGS

In order to describe the technical solutions in the embodiments of the present disclosure more clearly, the accompanying drawings required for describing the embodiments will be briefly introduced below. Apparently, the accompanying drawings in the following description show only some embodiments of the present disclosure, and those of ordinary skill in the art can still derive other accompanying drawings from these accompanying drawings without creative efforts.

FIG. 1 is a diagram of a method process of an array pickup method capable of steplessly adjusting a pickup direction provided in an embodiment of the present disclosure;

FIG. 2 is a schematic diagram of an application scenario of an array pickup method capable of steplessly adjusting a pickup direction provided in an embodiment of the present disclosure;

FIG. 3 is a schematic diagram of an audio processing process of an array pickup method capable of steplessly adjusting a pickup direction provided in an embodiment of the present disclosure;

FIG. 4 is a schematic diagram of a local audio processing process of an array pickup method capable of steplessly adjusting a pickup direction provided in an embodiment of the present disclosure;

FIG. 5 is a schematic effect diagram of an array pickup method capable of steplessly adjusting a pickup direction provided in an embodiment of the present disclosure;

FIG. 6 is a schematic diagram of another audio processing process of an array pickup method capable of steplessly adjusting a pickup direction provided in an embodiment of the present disclosure;

FIG. 7 is a diagram of another method process of an array pickup method capable of steplessly adjusting a pickup direction provided in an embodiment of the present disclosure;

FIG. 8 is a schematic diagram of another application scenario of an array pickup method capable of steplessly adjusting a pickup direction provided in an embodiment of the present disclosure;

FIG. 9 is a schematic diagram of a further audio processing process of an array pickup method capable of steplessly adjusting a pickup direction provided in an embodiment of the present disclosure;

FIG. 10 is a schematic diagram of a yet further audio processing process of an array pickup method capable of steplessly adjusting a pickup direction provided in an embodiment of the present disclosure;

FIG. 11 is a diagram of a further method process of an array pickup method capable of steplessly adjusting a pickup direction provided in an embodiment of the present disclosure;

FIG. 12 is a schematic diagram of a further application scenario of an array pickup method capable of steplessly adjusting a pickup direction provided in an embodiment of the present disclosure;

FIG. 13 is a schematic diagram of further another audio processing process of an array pickup method capable of steplessly adjusting a pickup direction provided in an embodiment of the present disclosure;

FIG. 14 is a diagram of a yet further method process of an array pickup method capable of steplessly adjusting a pickup direction provided in an embodiment of the present disclosure;

FIG. 15 is a schematic block diagram of an array pickup apparatus capable of steplessly adjusting a pickup direction provided in an embodiment of the present disclosure;

FIG. 16 is another schematic block diagram of an array pickup apparatus capable of steplessly adjusting a pickup direction provided in an embodiment of the present disclosure;

FIG. 17 is a further schematic block diagram of an array pickup apparatus capable of steplessly adjusting a pickup direction provided in an embodiment of the present disclosure;

FIG. 18 is a yet further schematic block diagram of an array pickup apparatus capable of steplessly adjusting a pickup direction provided in an embodiment of the present disclosure; and

FIG. 19 is a schematic block diagram of a computer device provided in an embodiment of the present disclosure.

### DETAILED DESCRIPTION OF THE INVENTION

Technical solutions in the embodiments of the present disclosure will be described clearly and completely below in conjunction with the accompanying drawings in the embodiments of the present disclosure. Apparently, the described embodiments are only a part of the embodiments of the present disclosure, not all the embodiments. Based on the embodiments in the present disclosure, all other embodiments obtained by those of ordinary skill in the art without creative efforts shall fall within the protection scope of the present disclosure.

It should be understood that when used in the present description and the appended claims, terms “include” and “contain” indicate the existence of described features, entireties, steps, operations, elements and/or components, but do not exclude the existence or addition of one or more other features, entireties, steps, operations, elements, components and/or sets thereof.

It should be further understood that the terms used in the description of the present disclosure are only intended to describe specific embodiments, rather than to limit the present disclosure. As used in the description and the appended claims of the present disclosure, a singular form “one”, “a” or “the” is intended to include a plural form unless other situations are clearly indicated in the context.

It should be further understood that the term “and/or” used in the description and the appended claims of the present disclosure refers to one or any combination or all possible combinations of related listed items and includes these combinations.

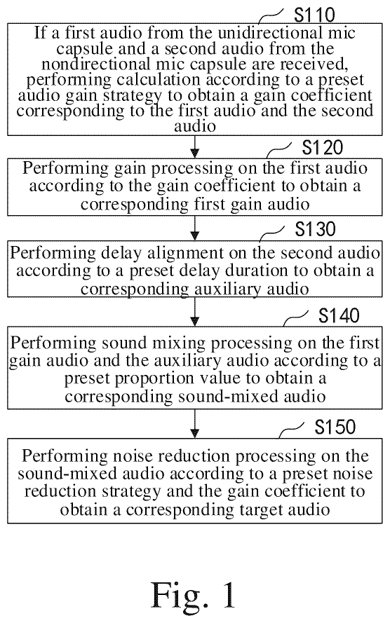

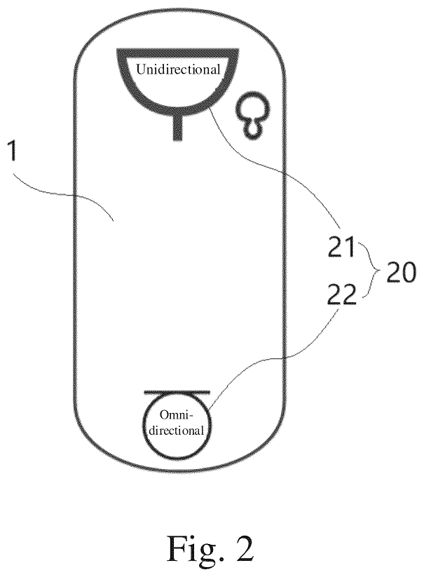

Referring to FIG. 1, as shown in the figure, an embodiment of the present disclosure provides an array pickup method capable of steplessly adjusting a pickup direction, wherein the method is applied to a pickup controller and is performed by application software assembled in the pickup controller. As shown in FIG. 2 to FIG. 15, communication connection is established between the pickup controller 10 and a directionality adjustable pickup array 20, the directionality adjustable pickup array 20 consists of a unidirectional mic capsule 21 and a nondirectional mic capsule 22, and thus, wired or wireless connection can be respectively established between the pickup controller 10 and each of mic capsules, for example, Bluetooth/radio frequency wireless connection can be established between the pickup controller 10 and each of the mic capsules, or wired connection can be established by a data transmission line. As shown in FIG. 1, the method includes steps S110-S150.

S110, if a first audio from the unidirectional mic capsule and a second audio from the nondirectional mic capsule are received, calculation is performed according to a preset audio gain strategy to obtain a gain coefficient corresponding to the first audio and the second audio.

The nondirectional mic capsule is also an omnidirectional mic capsule, the omnidirectional mic capsule and the unidirectional mic capsule are located in the same physical pickup component and are fixed in relative positions; the unidirectional mic capsule is a main pickup mic capsule, a pickup direction thereof is a main pickup direction, and it mainly picks up a human sound in the direction; the omnidirectional mic capsule is an auxiliary pickup mic capsule and can pick up more environmental noise; and a pickup array consisting of the omnidirectional mic capsule and the unidirectional mic capsule is shown in FIG. 2.

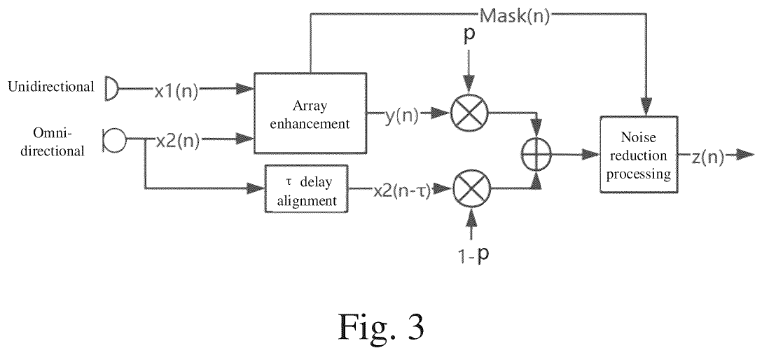

When directional sound reception is needed, a sound in the main pickup direction can be further enhanced by adopting an array algorithm, at the same time, noise in other directions can be inhibited, and thus, the directionality and sidelobe suppression capability higher than those of super-cardioid pickup can be achieved; and a final audio output can be achieved by sequentially performing delay alignment, proportional sound mixing and noise reduction processing on an array-enhanced output and an output of the omnidirectional mic capsule. For the directionality adjustable pickup array, a processing program diagram of a DSP (Digital Signal Processor) is shown in FIG. 3. An input of the unidirectional mic capsule is x1(t), an input of the nondirectional mic capsule is x2(t), and the inputs become digital signal sequences x1(n) and x2(n) after A/D sampling quantization; and the digital signal sequence x1(n) is also a digital signal sequence corresponding to the first audio, x2(n) is also a digital signal sequence corresponding to the second audio, and array enhancement processing can be firstly performed on the digital signal sequence corresponding to the first audio and the digital signal sequence corresponding to the second audio according to an audio gain strategy.

In a specific embodiment, step S110 includes sub-steps that: a first energy function corresponding to the first audio and a second energy function corresponding to the second audio are respectively calculated according to an average amplitude function in the audio gain strategy; and the first energy function and the second energy function are calculated according to a gain calculation formula in the audio gain strategy to obtain the gain coefficient corresponding to current audio frames.

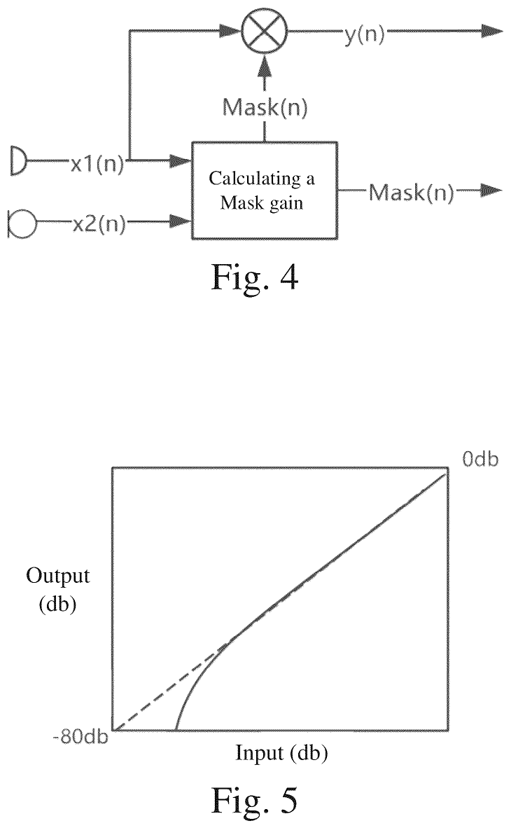

Array enhancement processing can be firstly performed on x1(n) and x2(n). In a specific embodiment, array enhancement processing can be performed by adopting a time domain differential array processing method based on a short-time energy function, and a specific processing process is shown in FIG. 4. Herein, if x1′(n) and x2′(n) obtained after gain calibration processing can be used for calculation, x1′(n) is a digital signal sequence obtained after gain calibration processing is performed on x1(n) according to a calibration coefficient, and x2′(n) is a digital signal sequence obtained after gain calibration processing is performed on x2(n) according to a calibration coefficient.

A first energy function E1′(n) corresponding to x1′(n) and a second energy function E2′(n) corresponding to x2′(n) are respectively calculated according to an average amplitude function, and a calculation formula of a short-time energy function E is shown as formula (1):

$${E}_{s} = {\sum }_{m = 0}^{N - 1} {x}^{2} ( m ) ; \qquad ( 1 )$$

wherein m is a summation variable of s^{th} frame data, N is a frame length, and n is a serial number of a sample point of the current audio frame.

Further, the first energy function and the second energy function can be calculated according to a gain calculation formula to obtain the gain coefficient corresponding to current audio frames. The gain calculation formula is shown as formula (2):

$$Mask ( n ) = {Mask}_{0} \times \frac{\vert E {1}^{′} ( n ) - E {2}^{′} ( n ) \vert}{\frac{E {1}^{′} ( n ) + E {2}^{′} ( n )}{2} + Δ} ; \qquad ( 2 )$$

wherein Δ is a minimal value and plays a role in preventing overhigh output in Mask gain calculation, Mask₀ is a normalized gain value, and a value thereof is a value enabling an average value of Mask(n) is 1 when a sound source at a 0.5 m point in a main pickup direction makes a sound.

In another embodiment, step S110 includes sub-steps that: short-time Fourier transform is respectively performed on the first audio and the second audio according to a transform calculation formula in the audio gain strategy to obtain a corresponding first frequency domain signal and second frequency domain signal; a first energy function corresponding to the first frequency domain signal and a second energy function corresponding to the second frequency domain signal are respectively calculated according to an average amplitude function in the audio gain strategy; and the first energy function and the second energy function are calculated according to a gain calculation formula in the audio gain strategy to obtain the gain coefficient corresponding to current audio frames.

In another embodiment, the audio gain strategy can also be a strategy corresponding to an array processing algorithm based on a frequency domain or a sub-band. Specifically, short-time Fourier transform can be firstly performed on the first audio and the second audio respectively according to a transform calculation formula, that is, x1′(n) and x2′(n) are firstly converted into frequency domain signals X1′(k,n) and X2′(k,n) by STFT (Short-Time Fourier Transform), wherein k in the brackets described herein represents a serial number of the sub-band; and thus, X1′(k,n) is a first frequency domain signal corresponding to the digital signal sequence of the first audio, and X2′(k,n) is a second frequency domain signal corresponding to the digital signal sequence of the second audio. A first energy function E1′(k,n) corresponding to X1′(k,n) is calculated according to formula (1), a second energy function E2′(k,n) corresponding to X2′(k,n) is calculated according to formula (1); and then, the corresponding gain coefficient is calculated with each ERB frequency band according to a gain calculation formula, wherein the gain coefficient is also a value of Mask(k,n), and a specific calculation process thereof is shown as formula (6):

$$Mask ( k , n ) = {Mask}_{0} \times \frac{\vert E {1}^{′} ( k , n ) - E {2}^{′} ( k , n ) \vert}{\frac{E {1}^{′} ( k , n ) + E {2}^{′} ( k , n )}{2} + Δ} ; \qquad ( 6 )$$

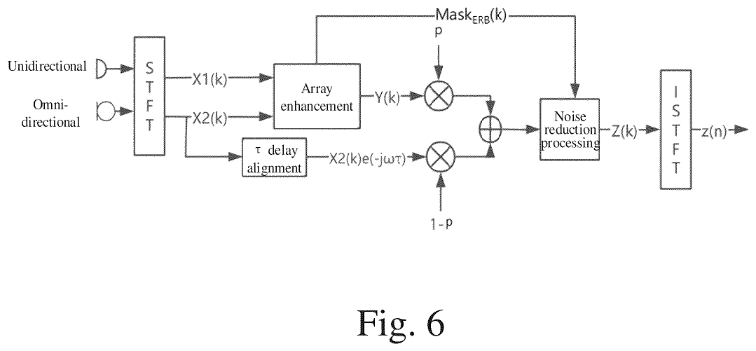

audio processing based on the gain coefficient Mask(k,n) is performed in subsequent steps and is applied to X1 (k,n) to obtain an array enhanced frequency domain signal Y(k,n), i.e., a first gain audio, and a specific process is calculated according to Y(k,n)=X1′(k,n)×Mask_{ERB}(k,n). Then, proportional sound mixing with a spectrum signal X2′(k, n−τ) of a delay-aligned and phase-calibrated auxiliary audio is performed to obtain a directionality adjustable spectrum output signal Y′(k,n), and a specific process thereof is calculated according to Y′(k,n)=k×Y(k,n)+(1−k)×X2′(k,n−τ), wherein k∈[0,1]. At the moment, Y′(k,n) is used as a sound-mixed audio to be further subjected to noise reduction processing to obtain a target audio, that is, frequency domain noise reduction processing is performed on each ERB frequency band to obtain Z(k,n), and a specific process thereof is calculated according to Z(k,n)=F_{DRC}(Mask_{ERB}(k,n),n)×Y′(k,n), wherein F_{DRC}(Mask_{ERB}(n),n) is a DRC processing function, and finally, ISTFT (Inverse Short-Time Fourier Transform) is performed on Z(k,n) to obtain a final time domain signal z(n), and thus, the obtained z(n) is the target audio. A specific process of the above-mentioned audio processing is shown in FIG. 6.

The time domain processing method and the frequency domain processing method in the present disclosure have different advantages and disadvantages, the time domain processing method has almost no delay, but has a slightly poor directional characteristic and noise reduction effect, and the frequency domain processing method is good in directional characteristic and noise reduction effect, but is slightly long in processing delay.

In a specific embodiment, before step S110, the array pickup method further includes steps that: a first test audio and a second test audio that are obtained by performing audio collection on a sound source on a preset position by the mic capsules are acquired; wherein the preset position is a position in a normal direction of a mic capsule connecting line and away from the mic capsule connecting line for a preset distance; and the mic capsule connecting line is a connecting line between the unidirectional mic capsule and the nondirectional mic capsule or a connecting line between the unidirectional mic capsule and a composite pickup mic capsule; and calibration coefficients corresponding to the unidirectional mic capsule and another mic capsule are respectively allocated according to sound volumes of the first test audio and the second test audio, so that average output sound volumes of the first test audio and the second test audio respectively calibrated according to the calibration coefficients are the same.

Further, the sensitivity of the omnidirectional mic capsule and the unidirectional mic capsule in the above-mentioned embodiment are not necessarily the same, in order to improve the quality of an audio acquired by pickup, before the formal use and collection of the first audio and the second audio, gain calibration processing can be further performed. Specifically, a point sound source can be located in the normal direction of the mic capsule connecting line and away from the mic capsule connecting line for a distance d, that is, a preset distance is d; the calibration coefficients are adjusted, so that average output sound volumes of two omnidirectional mic capsules and the unidirectional mic capsule that are calibrated are the same, that is, two mic capsules are calibrated according to the calibration coefficients so that average output amplitudes of the two mic capsules are the same, and thus, different calibration coefficients are correspondingly allocated for different mic capsules. For example, if a calibration coefficient allocated to the unidirectional mic capsule is 0.8, and a calibration coefficient allocated to the omnidirectional mic capsule is 1.1, a calibrated audio is obtained by multiplying the loudness of the audio collected by the unidirectional mic capsule by 0.8; and a calibrated audio is obtained by multiplying the loudness of the audio collected by the omnidirectional mic capsules by 1.1. A value of d depends on a use scenario of a mike, for example, a distance of a handheld mike is generally expressed as d=0.5 m-1 m. If output signals of gain calibrated mic capsules are x1′(n) and ×2′(n), in the subsequent processing steps, an audio obtained after gain calibration processing is performed on an audio collected by the omnidirectional mic capsule can be used as the second audio, and an audio obtained after gain calibration processing is performed on an audio collected by the unidirectional mic capsule can be used as the first audio.

S120, gain processing is performed on the first audio according to the gain coefficient to obtain a corresponding first gain audio.

Gain processing is performed on the first audio according to the obtained a gain coefficient to obtain a first gain audio, i.e., an array enhanced output y(n), and a specific calculation process thereof is shown as formula (3):

$$y ( n ) = x {1}^{′} ( n ) \times Mask ( n ) . \qquad ( 3 )$$

S130, delay alignment is performed on the second audio according to a preset delay duration to obtain a corresponding auxiliary audio.

Delay alignment can be performed on the second audio according to a preset delay duration, that is, delay alignment is performed on x2′(n), and thus, a specific expression of the obtained auxiliary audio is x2′(t−τ), wherein t is an audio frame time of the second audio, and τ is a delay duration. A value of τ in above formula depends on a distance between the unidirectional mic capsule and the omnidirectional mic capsule and a sampling rate and aims at ensuring that two mic capsules have the same phase when picking up a sound in a main pickup direction.

S140, sound mixing processing is performed on the first gain audio and the auxiliary audio according to a preset proportion value to obtain a corresponding sound-mixed audio.

Sound mixing processing is performed on the first gain audio and the auxiliary audio according to a preset proportion value, the proportion value is also a sound mixing proportion coefficient p, a value of p is within a range of [0,1], when the value of p is higher, an output ratio of an array enhancement algorithm is higher, and the pickup directionality is better, and when the value of p is lower, an output ratio of the omnidirectional mic capsule is higher, and more sounds in other directions can be picked up. A specific process for sound mixing processing is shown as formula (4)

$${y}^{′} ( n ) = p \times y ( n ) + ( 1 - p ) \times x {2}^{′} ( t - τ ) ; \qquad ( 4 )$$

thus, the obtained sound-mixed audio is y′(n); and in above formula, p is a sound mixing proportion, the larger the value of p is, the higher the ratio in the output y(n) is, therefore, the stronger the directionality of the output y′(n) is, and conversely, the weaker the directionality of the output y′(n) is.

S150, noise reduction processing is performed on the sound-mixed audio according to a preset noise reduction strategy and the gain coefficient to obtain a corresponding target audio.

Finally, noise reduction processing is performed on the sound-mixed audio according to a preset noise reduction strategy and the above-mentioned gain coefficient, that is, noise reduction processing is performed on y′(n) to obtain z(n), and thus, z(n) is the obtained target audio; the object of the noise reduction processing is to further enhance a pickup difference between a signal in the main pickup direction and environmental noise in other directions, and in the present embodiment, noise reduction processing is achieved by adopting a nonlinear compression method similar to a dynamic range control. Differences from traditional DRC for achieving noise gate processing are that an instantaneous gain of the traditional DRC depends on an input envelope amplitude of the current signal, while the instantaneous gain in the present embodiment depends on a Mask gain of the current frame. A specific noise reduction processing process is shown as formula (5):

$$z ( n ) = {f}_{DRC} ( Mask ( n ) , n ) \times {y}^{′} ( n ) ; \qquad ( 5 )$$

wherein f_{DRC}(Mask(n),n) is a DRC processing function, a function curve thereof is shown in FIG. 5, Mask (n) is used as an input of the function, and f_{DRC}(Mask(n),n) is used as an output.

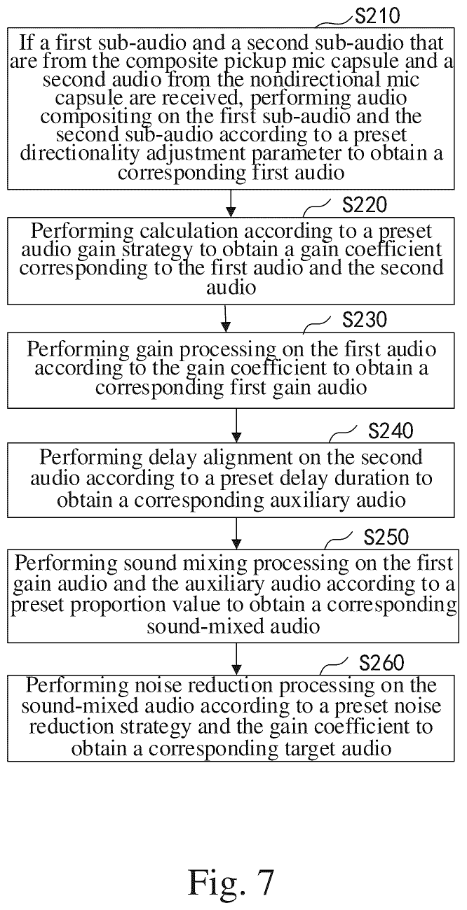

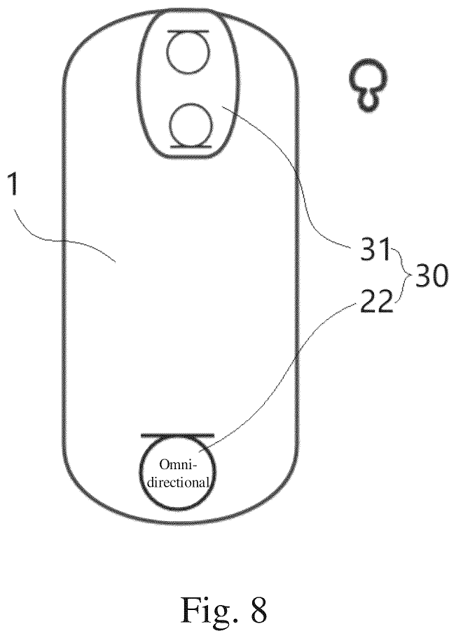

Referring to FIG. 7, as shown in the figure, an embodiment of the present disclosure provides an array pickup method capable of steplessly adjusting a pickup direction, wherein the method is applied to a pickup controller and is performed by application software assembled in the pickup controller. As shown in FIG. 8 to FIG. 16, communication connection is established between the pickup controller 10 and a composite differential pickup array 30, the composite differential pickup array 30 consists of a composite pickup mic capsule 31 and a nondirectional mic capsule 22, and the composite pickup mic capsule 31 is symmetrically combined by two nondirectional mic capsules. As shown in FIG. 7, the method includes steps S210-S260.

S210, if a first sub-audio and a second sub-audio that are from the composite pickup mic capsule and a second audio from the nondirectional mic capsule are received, audio compositing is performed on the first sub-audio and the second sub-audio according to a preset directionality adjustment parameter to obtain a corresponding first audio.

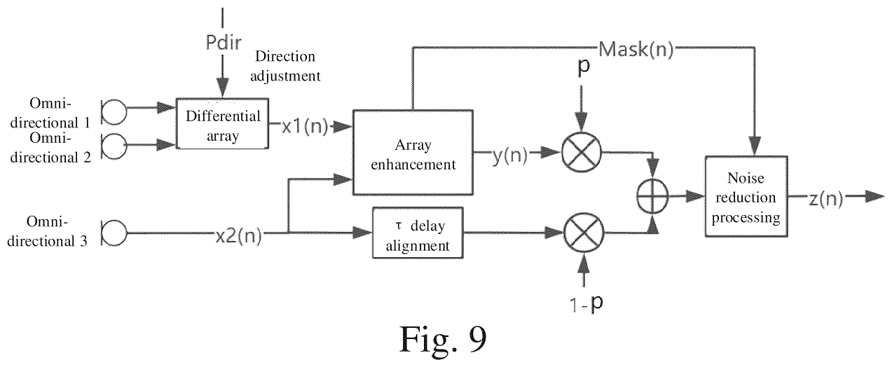

Two nondirectional mic capsules (omnidirectional mic capsules) are stacked to be combined to obtain the composite pickup mic capsule and replace the unidirectional mic capsule in the above-mentioned embodiment, thereby obtaining the composite differential pickup array shown in FIG. 8. A process of a time-domain-based processing algorithm is shown in FIG. 9.

The composite pickup mic capsule can perform corresponding collection by means of two nondirectional mic capsules therein to obtain a first sub-audio and a second sub-audio, and therefore, a directionality adjustment parameter Pdir needs to be introduced by which the directionality of an output of a differential array can be controlled, so that a pickup apparatus finally outputs to obtain a wider directionality adjustment range by which bidirectional pickup can be achieved.

S220, calculation is performed according to a preset audio gain strategy to obtain a gain coefficient corresponding to the first audio and the second audio. S230, gain processing is performed on the first audio according to the gain coefficient to obtain a corresponding first gain audio. S240, delay alignment is performed on the second audio according to a preset delay duration to obtain a corresponding auxiliary audio. S250, sound mixing processing is performed on the first gain audio and the auxiliary audio according to a preset proportion value to obtain a corresponding sound-mixed audio. S260, noise reduction processing is performed on the sound-mixed audio according to a preset noise reduction strategy and the gain coefficient to obtain a corresponding target audio.

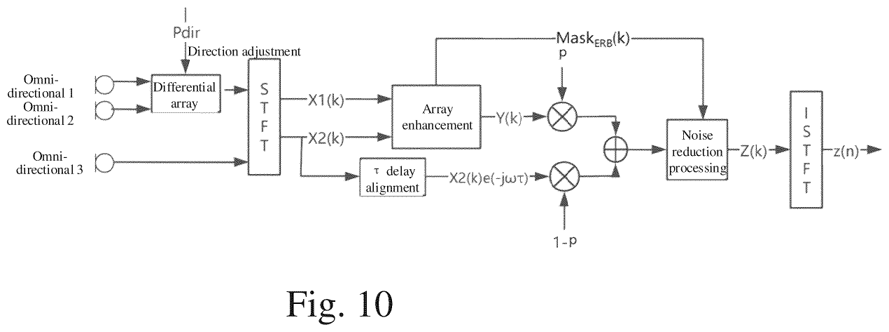

A specific process that calculation is performed according to a preset audio gain strategy to obtain a gain coefficient corresponding to the first audio and the second audio can also be achieved on the basis of a time domain processing method or a frequency domain processing method, wherein a processing process based on the frequency domain processing method is shown in FIG. 10, and a processing process based on the time domain processing method is shown in FIG. 9. Actual processing processes of steps S220 to S260 are similar to the processing processes of steps S110 to S150 so as not to be repeated herein.

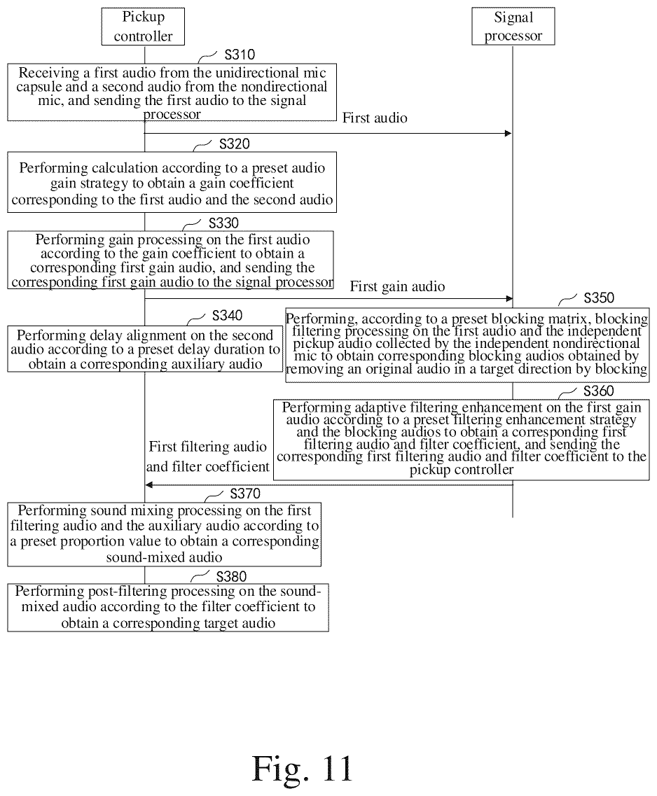

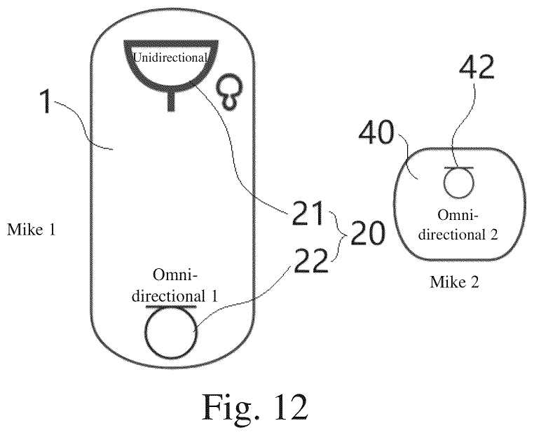

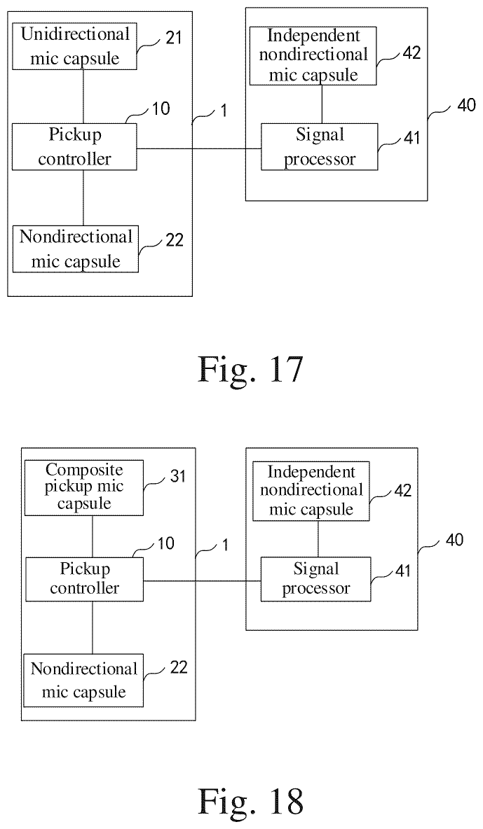

Referring to FIG. 11, as shown in the figure, an embodiment of the present disclosure provides an array pickup method capable of steplessly adjusting a pickup direction, wherein the method is applied to a pickup controller and a signal processor and is performed by application software assembled in the pickup controller and the signal processor. As shown in FIG. 12 and FIG. 17, the pickup controller 10 is respectively in communication connection with a directionality adjustable pickup array 20 and the signal processor 41, and the directionality adjustable pickup array 20 consists of a unidirectional mic capsule 21 and a nondirectional mic capsule 22. Wired or wireless communication connection can be established between the pickup controller 10 and the signal processor 41, and the signal processor 41 is in communication connection with an independent nondirectional mic capsule 42 so as to acquire a corresponding independent pickup audio from the independent nondirectional mic capsule 42. As shown in FIG. 11, the method includes steps S310-S380.

S310, if a first audio from the unidirectional mic capsule and a second audio from the nondirectional mic capsule are received, the pickup controller sends the first audio to the signal processor; S320, the pickup controller performs calculation according to a preset audio gain strategy to obtain a gain coefficient corresponding to the first audio and the second audio; S330, the pickup controller performs gain processing on the first audio according to the gain coefficient to obtain a corresponding first gain audio, and sends the corresponding first gain audio to the signal processor; S340, the pickup controller performs delay alignment on the second audio according to a preset delay duration to obtain a corresponding auxiliary audio; S350, the signal processor performs, according to a preset blocking matrix, blocking filtering processing on the first audio and the independent pickup audio collected by the independent nondirectional mic capsule to obtain corresponding blocking audios obtained by removing an original audio in a target direction by blocking; S360, the signal processor preforms adaptive filtering enhancement on the first gain audio according to a preset filtering enhancement strategy and the blocking audios to obtain a corresponding first filtering audio and filter coefficient, and sends the corresponding first filtering audio and filter coefficient to the pickup controller; S370, the pickup controller performs sound mixing processing on the first filtering audio and the auxiliary audio according to a preset proportion value to obtain a corresponding sound-mixed audio; and S380, the pickup controller performs post-filtering processing on the sound-mixed audio according to the filter coefficient to obtain a corresponding target audio.

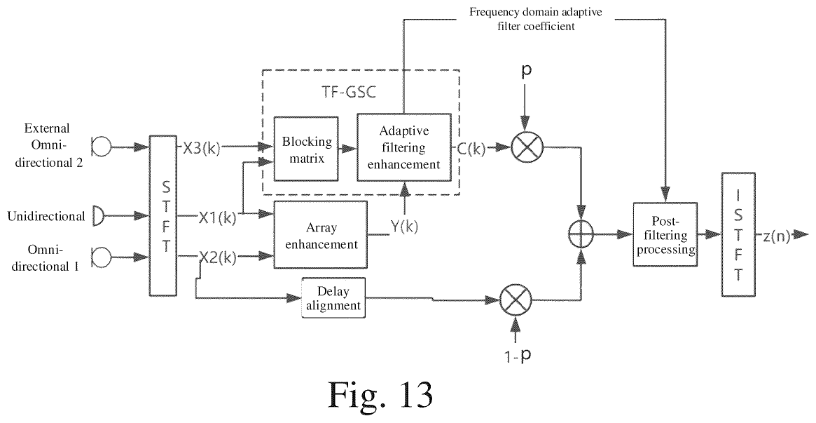

In the present embodiment, a device corresponding to the independent nondirectional mic capsule can be used as an independent pickup mike, and thus, the independent nondirectional mic capsule is used as a mike 2, and the directionality adjustable pickup array is used as a mike 1. A distance between the mike 2 and the mike 1 and relative positions of the mike 2 and the mike 1 are not fixed, and the mike 1 and the mike 2 can form a distributed pickup array to form a better noise reduction effect. The mike 2 in FIG. 12 is generally an accessory apparatus of the mike 1, other than a completely independent device, for example, when the mike 1 is a wireless mike, the mike 2 may be an auxiliary pickup mic capsule located on a receiver of the mike 1 (i.e., the mike 2 in FIG. 12), plays a role in receiving more environmental sounds, can further enhance the noise reduction effect during unidirectional pickup, and can more uniformly pick up sounds in all directions during omnidirectional pickup at the same time. A DSP processing process performed by the pickup controller and the signal processor is shown in FIG. 13, and first-level TF-GSC array processing is additionally increased as comparison with the above-mentioned embodiment in which the directionality adjustable pickup array is only disposed. TF-GSC is Transfer Function Generalized Sidelobe Canceler. Differences from a GSC (Generalized Sidelobe Canceler) algorithm are that an external independent nondirectional mic capsule is actually disposed on the mike 2 (the mike 2 is used as the receiver of the mike 1), and thus, a TF-GSC array in FIG. 13 is actually located on the signal processor in communication connection with the independent nondirectional mic capsule. The signal processor acquires a first gain audio of the mike 1 (i.e., an array enhanced output y(k)) as a main input, acquires the independent pickup audio collected by the independent nondirectional mic capsule itself as an auxiliary input, outputs C(k) as a first filtering audio after performing TF-GSC processing, and performs frequency domain post-filtering processing after performing proportional sound mixing on the first filtering audio C(k) and the auxiliary audio X(2) on the basis of a preset proportion value, wherein the post-filtering described herein is a typical log-MMSE post-filtering algorithm other than the foregoing DRC-based noise reduction algorithm, and thus, the corresponding target audio is obtained. The original audio in the target direction in step S350 is an original audio with the same direction as the finally obtained target audio, and the original audio in the target direction is an original audio not processed in step S360 to step S380 and corresponding to the target audio.

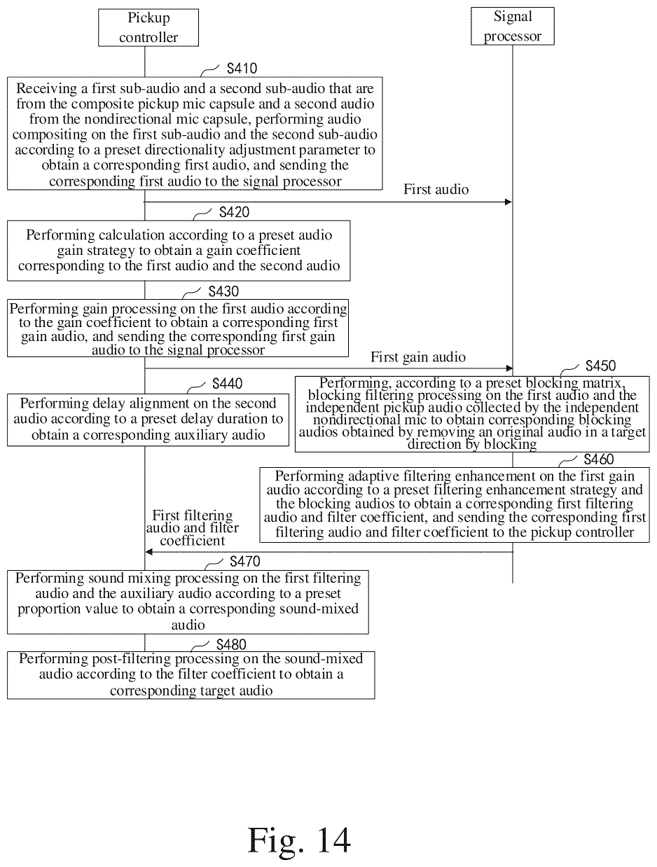

Referring to FIG. 14, as shown in the figure, an embodiment of the present disclosure provides an array pickup method capable of steplessly adjusting a pickup direction, wherein the method is applied to a pickup controller and a signal processor and is performed by application software assembled in the pickup controller and the signal processor. As shown in FIG. 18, the pickup controller 10 is respectively in communication connection with a composite differential pickup array 30 and the signal processor 41, the composite differential pickup array 30 consists of a composite pickup mic capsule 31 and a nondirectional mic capsule 22, the composite pickup mic capsule 31 is symmetrically combined by two nondirectional mic capsules, and the signal processor 41 is in communication connection with an independent nondirectional mic capsule 42 so as to acquire a corresponding independent pickup audio from the independent nondirectional mic capsule 42. As shown in FIG. 14, the method includes steps S410-S480.

S410, if a first sub-audio and a second sub-audio that are from the composite pickup mic capsule and a second audio from the nondirectional mic capsule are received, the pickup controller performs audio compositing on the first sub-audio and the second sub-audio according to a preset directionality adjustment parameter to obtain a corresponding first audio, and sends the corresponding first audio to the signal processor; S420, the pickup controller performs calculation according to a preset audio gain strategy to obtain a gain coefficient corresponding to the first audio and the second audio; S430, the pickup controller performs gain processing on the first audio according to the gain coefficient to obtain a corresponding first gain audio, and sends the corresponding first gain audio to the signal processor; S440, the pickup controller performs delay alignment on the second audio according to a preset delay duration to obtain a corresponding auxiliary audio; S450, the signal processor performs, according to a preset blocking matrix, blocking filtering processing on the first audio and the independent pickup audio collected by the independent nondirectional mic capsule to obtain corresponding blocking audios obtained by removing an original audio in a target direction by blocking; S460, the signal processor performs adaptive filtering enhancement on the first gain audio according to a preset filtering enhancement strategy and the blocking audios to obtain a corresponding first filtering audio and filter coefficient, and sends the corresponding first filtering audio and filter coefficient to the pickup controller; S470, the pickup controller performs sound mixing processing on the first filtering audio and the auxiliary audio according to a preset proportion value to obtain a corresponding sound-mixed audio; and S480, the pickup controller performs post-filtering processing on the sound-mixed audio according to the filter coefficient to obtain a corresponding target audio.

In addition, the unidirectional mic capsule in FIG. 12 can also be replaced with a composite differential pickup array in a similar way, at the moment, the DSP processing process is completely consistent with the processing in FIG. 13 except that audio compositing processing for a first sub-audio and a second sub-audio acquired by two nondirectional mic capsules of the composite differential pickup array is increased.

In the array pickup method capable of steplessly adjusting the pickup direction disclosed in the above-mentioned embodiment, the method includes: a first audio from a unidirectional mic capsule and a second audio from a nondirectional mic capsule are received and calculated to obtain a gain coefficient; gain processing is performed on the first audio according to the gain coefficient to obtain a first gain audio; delay alignment is performed on the second audio to obtain an auxiliary audio; sound mixing processing is performed on the first gain audio and the auxiliary audio according to a proportion value to obtain a sound-mixed audio; and noise reduction processing is performed on the sound-mixed audio according to a noise reduction strategy and the gain coefficient to obtain a corresponding target audio. The above-mentioned method is used in combination with an array pickup apparatus capable of steplessly and gradually adjusting a pickup direction, two or more mic capsules with different pickup directions are utilized to form a pickup array, the wide-range stepless adjustment for pickup directionality is achieved by means of a specific microphone array algorithm, and at the same time, a noise reduction function stronger than that of traditional single mic capsule or simple array pickup is achieved in combination with an array post-processing noise reduction algorithm.

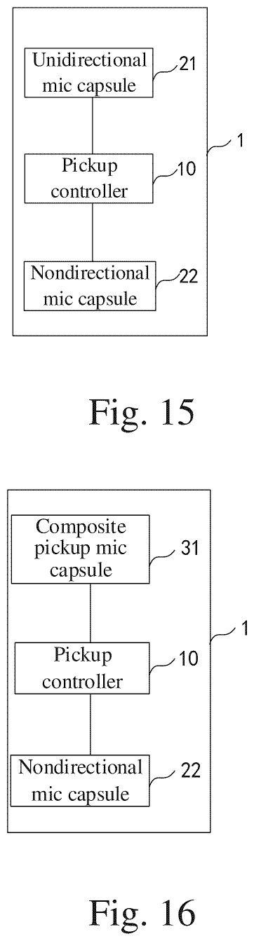

An embodiment of the present disclosure further provides an array pickup apparatus capable of steplessly adjusting a pickup direction, wherein the array pickup apparatus capable of steplessly adjusting the pickup direction includes an apparatus body 1, a pickup controller 10 and a directionality adjustable pickup array 20, the pickup controller 10 in the array pickup apparatus capable of steplessly adjusting the pickup direction is used for performing the method steps that correspond to the directionality adjustable pickup array 20 and can be performed in the pickup controller 10 in the foregoing array pickup method capable of steplessly adjusting the pickup direction. Specifically, referring to FIG. 15 which is a schematic block diagram of an array pickup apparatus capable of steplessly adjusting a pickup direction provided in an embodiment of the present disclosure.

As shown in FIG. 15, the pickup controller 10 is disposed in the apparatus body 1; the directionality adjustable pickup array 20 consists of a unidirectional mic capsule 21 and a nondirectional mic capsule 22; the unidirectional mic capsule 21 and the nondirectional mic capsule 22 are both disposed on the same outer surface of the apparatus body 1; a pickup direction of the unidirectional mic capsule 21 faces away from the nondirectional mic capsule 22; and the pickup controller 10 is respectively in communication connection with the unidirectional mic capsule 21 and the nondirectional mic capsule 22.

The array pickup apparatus capable of steplessly adjusting the pickup direction can be a small-size pickup mike, a pickup pen, a wireless clip-on microphone, a pickup headset box, a pickup watch and other apparatuses.

The array pickup apparatus in FIG. 15 is additionally provided with an independent pickup device 40 so that a structure of the array pickup apparatus shown in FIG. 17 can be obtained, wherein the independent pickup device 40 includes a signal processor 41 and an independent nondirectional mic capsule 42 that are in communication connection, and the signal processor 41 is in communication connection with the pickup controller 42; the signal processor 41 is in communication connection with the pickup controller 10; the apparatus body 1 is provided with a fixing component for fixing the independent pickup device 40; and during use, the independent pickup device 40 is disassembled from the apparatus body 1 to perform independent pickup and is combined with the apparatus body 1 for use. Thus, the signal processor 41 in the independent pickup device 40 can be used for performing the method steps that correspond to the directionality adjustable pickup array 20 and can be performed in the signal processor 41 in the foregoing array pickup method capable of steplessly adjusting the pickup direction. The independent pickup device 40 can be set as an independent small-size mike, is detachably assembled on the apparatus body 1, and can be disassembled from the apparatus body 1 and used for independent pickup when required to be used.

An embodiment of the present disclosure further provides an array pickup apparatus capable of steplessly adjusting a pickup direction, wherein the array pickup apparatus capable of steplessly adjusting the pickup direction includes an apparatus body 1, a pickup controller 10 and a composite differential pickup array 30, the pickup controller 10 in the array pickup apparatus capable of steplessly adjusting the pickup direction is used for performing the method steps that correspond to the composite differential pickup array 30 and can be performed in the pickup controller 10 in the foregoing array pickup method capable of steplessly adjusting the pickup direction. Specifically, referring to FIG. 16 which is a schematic block diagram of an array pickup apparatus capable of steplessly adjusting a pickup direction provided in an embodiment of the present disclosure.

As shown in FIG. 16, the pickup controller 10 is disposed in the apparatus body 1; the composite differential pickup array 30 consists of a composite pickup mic capsule 31 and a nondirectional mic capsule 22, and the composite pickup mic capsule 31 is symmetrically combined by two nondirectional mic capsules; the composite pickup mic capsule 31 and the nondirectional mic capsule 22 are both disposed on the same outer surface of the apparatus body 1; the three nondirectional mic capsules 22 are arranged on the same straight line, and a distance between the two nondirectional mic capsules in the composite pickup mic capsule 31 is smaller than a distance between the composite pickup mic capsule 31 and the nondirectional mic capsule 22 disposed alone; and the pickup controller 10 is respectively in communication connection with the three nondirectional mic capsules 22.

The array pickup apparatus in FIG. 16 is additionally provided with an independent pickup device 40 so that a structure of the array pickup apparatus shown in FIG. 18 can be obtained, wherein the independent pickup device 40 includes a signal processor 41 and an independent nondirectional mic capsule 42 that are in communication connection, and the signal processor 41 is in communication connection with the pickup controller 42; the signal processor 41 is in communication connection with the pickup controller 10; the apparatus body 1 is provided with a fixing component for fixing the independent pickup device 40; and during use, the independent pickup device 40 is disassembled from the apparatus device 1 to perform independent pickup and is combined with the apparatus body 1 for use. Thus, the signal processor 41 in the independent pickup device 40 can be used for performing the method steps that correspond to the composite differential pickup array 30 and can be performed in the signal processor 41 in the foregoing array pickup method capable of steplessly adjusting the pickup direction.

The array pickup apparatus capable of steplessly adjusting the pickup direction provided in the embodiment of the present disclosure applies the above-mentioned array pickup method capable of steplessly adjusting the pickup direction to receive and calculate a first audio from a unidirectional mic capsule and a second audio from a nondirectional mic capsule to obtain a gain coefficient; perform gain processing on the first audio according to the gain coefficient to obtain a first gain audio; perform delay alignment on the second audio to obtain an auxiliary audio; perform sound mixing processing on the first gain audio and the auxiliary audio according to a proportion value to obtain a sound-mixed audio; and perform noise reduction processing on the sound-mixed audio according to a noise reduction strategy and the gain coefficient to obtain a corresponding target audio. The above-mentioned method is used in combination with an array pickup apparatus capable of steplessly and gradually adjusting a pickup direction, two or more mic capsules with different pickup directions are utilized to form a pickup array, the wide-range stepless adjustment for pickup directionality is achieved by means of a specific microphone array algorithm, and at the same time, a noise reduction function stronger than that of traditional single mic capsule or simple array pickup is achieved in combination with an array post-processing noise reduction algorithm.

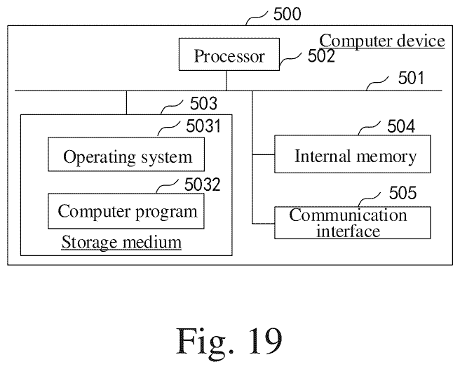

The above-mentioned array pickup method capable of steplessly adjusting the pickup direction can be achieved in a form of a computer program which can operate on a computer device shown in FIG. 19.

Referring to FIG. 19 which is a schematic block diagram of a computer device provided in an embodiment of the present disclosure, the computer device can be an MCU chip used for performing the array pickup method capable of steplessly adjusting the pickup direction so as to achieve array pickup processing capable of steplessly adjusting the pickup direction.

Referring to FIG. 19, the computer device 500 includes a processor 502, a memory and a communication interface 505 that are connected by a communication bus 501, wherein the memory can include a storage medium 503 and an internal memory 504.

The storage medium 503 can store an operating system 5031 and a computer program 5032. The computer program 5032, when executed, enables the processor 502 to perform the array pickup method capable of steplessly adjusting the pickup direction, wherein the storage medium 503 can be a volatile storage medium or a nonvolatile storage medium.

The processor 502 is used for providing calculation and control capabilities and supporting the operation of the whole computer device 500.

The internal memory 504 provides an environment for the operation of the computer program 5032 in the storage medium 503, and the computer program 5032, when executed by the processor 502, enables the processor 502 to perform the array pickup method capable of steplessly adjusting the pickup direction.

The communication interface 505 is used for network communication, such as providing transmission of data information, etc. It can be understood by the skilled in the art that the structure shown in FIG. 19 is only a block diagram of parts of structures related to the solutions of the present disclosure, and does not constitute a limitation on the computer device 500 to which the solutions of the present disclosure are applied, and the specific computer device 500 can include more or fewer components than those shown in the figure, or combine with some components, or have different component layout.

The processor 502 is used for operating the computer program 5032 stored in the memory so as to achieve the corresponding functions in the above-mentioned array pickup method capable of steplessly adjusting the pickup direction.

It can be understood by the skilled in the art that the embodiment of the computer device shown in FIG. 19 does not constitute a limitation on a specific structure of the computer device, and in other embodiments, the computer device can include more or fewer components than those shown in the figure, or combine with some components, or have different component layout. For example, in some embodiments, the computer device can only include a memory and a processor, and in such embodiments, structures and functions of the memory and the processor are consistent to those in the embodiment shown in FIG. 19 so as to be no longer repeated herein.

It should be understood that in the embodiment of the present disclosure, the processor 502 can be a CPU (Central Processing Unit), and the processor 502 can also be other general-purpose processors, a DSP (Digital Signal Processor), an ASIC (Application Specific Integrated Circuit), an FPGA (Field-Programmable Gate Array) or other programmable logic devices, a discrete gate or transistor logic device, a discrete hardware component, etc. A general-purpose processor can be a microprocessor or any conventional processor, etc.

Another embodiment of the present disclosure provides a computer-readable storage medium. The computer-readable storage medium can be a volatile or nonvolatile computer-readable storage medium. The computer-readable storage medium stores a computer program, wherein the computer program, when executed by a processor, implements the steps included in the above-mentioned array pickup method capable of steplessly adjusting the pickup direction.

It can be clearly known by the skilled in the art that, for facilitating and simplifying the description, specific working processes of the device, apparatus and unit described above can referring to corresponding processes in the foregoing method embodiment so as to be no longer repeated herein. Those of ordinary skill in the art can realize that the units and algorithm steps in all examples described in conjunction with the embodiments disclosed herein can be implemented by electronic hardware, computer software or a combination of both. In order to describe the interchangeability of the hardware and the software clearly, constitution and steps of all the examples have been described generally in the above description according to functions. Whether these functions are implemented by hardware or software depends upon specific applications and design constraints of the technical solutions. The skilled in the art can adopt different methods to achieve the described functions in each specific application, which, however, should be considered as falling within the scope of the present disclosure.

In several embodiments provided by the present disclosure, it should be understood that the disclosed device, apparatus and method can be implemented in other ways. For example, the apparatus embodiment described above is only schematic. For example, the division of units is only logic function division, there can be other division ways during actual implementation, and units having the same functions can also be integrated into a unit, for example, a plurality of units or components can be combined or integrated to another system, or some features can be ignored or not be performed. In addition, the shown or discussed coupling or direct coupling or communication connection with each other can be indirect coupling or communication connection by means of some interfaces, apparatuses or units, or electric connection, mechanical connection or connection in other forms.

The units described as separate components can be or not be physically separated, and components displayed as units can be or not be physical units, that is, they can be located on the same place or distributed on a plurality of network units. Parts or all of the units can be selected according to an actual demand to achieve the purposes of the solutions in the embodiments of the present disclosure.

In addition, all functional units in all the embodiments of the present disclosure can be integrated in a processing unit, or all the units physically exist alone, or two or more units are integrated in a unit. The above-mentioned integrated unit can be implemented in a form of hardware or a software functional unit.

If the integrated unit is implemented in the form of the software functional unit and sold or used as an independent product, the integrated unit can be stored in a computer-readable storage medium. Based on such understanding, the essences of the above-mentioned technical solutions or parts thereof making contributions to the prior art or all or parts of the technical solutions can be embodied in a form of a software product, and the computer software product is stored in a computer-readable storage medium including a plurality of instructions so that a computer device (that can be a circuit board, a data processing chip, etc.) performs all or parts of the steps of the method in each of the embodiments of the present disclosure. The foregoing computer-readable storage medium includes a U disk, a mobile hard disk, an ROM (Read-Only Memory), a diskette, or a compact disc, and various other media capable of storing program codes.

The above descriptions are only specific implementations of the present disclosure, but the protection scope of the present disclosure is not limited thereto. All equivalent modifications or substitutions can be easily conceived by those skilled in the art within the technical scope disclosed by the present disclosure, and these modifications or substitutions shall fall within the protection scope of the present disclosure. Therefore, the protection scope of the present disclosure should be subject to the protection scope defined in the claims.

1. An array pickup method capable of steplessly adjusting a pickup direction, wherein the method is applied to a pickup controller, the pickup controller is in communication connection with a directionality adjustable pickup array, the directionality adjustable pickup array consists of a unidirectional mic capsule and a nondirectional mic capsule, and the method comprises:
if a first audio from the unidirectional mic capsule and a second audio from the nondirectional mic capsule are received, performing calculation according to a preset audio gain strategy to obtain a gain coefficient corresponding to the first audio and the second audio;
performing gain processing on the first audio according to the gain coefficient to obtain a corresponding first gain audio;
performing delay alignment on the second audio according to a preset delay duration to obtain a corresponding auxiliary audio;
performing sound mixing processing on the first gain audio and the auxiliary audio according to a preset proportion value to obtain a corresponding sound-mixed audio; and
performing noise reduction processing on the sound-mixed audio according to a preset noise reduction strategy and the gain coefficient to obtain a corresponding target audio.

2. The array pickup method capable of steplessly adjusting the pickup direction of claim 1, wherein the method further comprises:
acquiring a first test audio and a second test audio that are obtained by performing audio collection on a sound source on a preset position by the mic capsules; wherein the preset position is a position in a normal direction of a mic capsule connecting line and away from the mic capsule connecting line for a preset distance; and the mic capsule connecting line is a connecting line between the unidirectional mic capsule and the nondirectional mic capsule; and
configuring calibration coefficients respectively corresponding to the unidirectional mic capsule and another mic capsule according to sound volumes of the first test audio and the second test audio, so that average output sound volumes of the first test audio and the second test audio respectively calibrated according to the calibration coefficients are the same.

3. The array pickup method capable of steplessly adjusting the pickup direction of claim 2, wherein the performing calculation according to a preset audio gain strategy to obtain a gain coefficient corresponding to the first audio and the second audio comprises:
respectively calculating a first energy function corresponding to the first audio and a second energy function corresponding to the second audio according to an average amplitude function in the audio gain strategy; and
calculating the first energy function and the second energy function according to a gain calculation formula in the audio gain strategy to obtain the gain coefficient corresponding to current audio frames.

4. The array pickup method capable of steplessly adjusting the pickup direction of claim 2, wherein the performing calculation according to a preset audio gain strategy to obtain a gain coefficient corresponding to the first audio and the second audio comprises:
respectively performing short-time Fourier transform on the first audio and the second audio according to a transform calculation formula in the audio gain strategy to obtain a corresponding first frequency domain signal and second frequency domain signal;
respectively calculating a first energy function corresponding to the first frequency domain signal and a second energy function corresponding to the second frequency domain signal according to an average amplitude function in the audio gain strategy; and
calculating the first energy function and the second energy function according to a gain calculation formula in the audio gain strategy to obtain a frequency domain sub-band gain coefficient as the gain coefficient corresponding to current audio frames.

5. An array pickup method capable of steplessly adjusting a pickup direction, wherein the method is applied to a pickup controller, the pickup controller is in communication connection with a composite differential pickup array, the composite differential pickup array consists of a composite pickup mic capsule and a nondirectional mic capsule, the composite pickup mic capsule is symmetrically combined by two nondirectional mic capsules, and the method comprises:
if a first sub-audio and a second sub-audio that are from the composite pickup mic capsule and a second audio from the nondirectional mic capsule are received, performing audio compositing on the first sub-audio and the second sub-audio according to a preset directionality adjustment parameter to obtain a corresponding first audio;
performing calculation according to a preset audio gain strategy to obtain a gain coefficient corresponding to the first audio and the second audio;
performing gain processing on the first audio according to the gain coefficient to obtain a corresponding first gain audio;
performing delay alignment on the second audio according to a preset delay duration to obtain a corresponding auxiliary audio;
performing sound mixing processing on the first gain audio and the auxiliary audio according to a preset proportion value to obtain a corresponding sound-mixed audio; and
performing noise reduction processing on the sound-mixed audio according to a preset noise reduction strategy and the gain coefficient to obtain a corresponding target audio.

6. The array pickup method capable of steplessly adjusting the pickup direction of claim 5, wherein the method further comprises:
acquiring a first test audio and a second test audio that are obtained by performing audio collection on a sound source on a preset position by the mic capsules; wherein the preset position is a position in a normal direction of a mic capsule connecting line and away from the mic capsule connecting line for a preset distance; and the mic capsule connecting line is a connecting line between the unidirectional mic capsule and the composite pickup mic capsule; and
configuring calibration coefficients respectively corresponding to the unidirectional mic capsule and another mic capsule according to sound volumes of the first test audio and the second test audio, so that average output sound volumes of the first test audio and the second test audio respectively calibrated according to the calibration coefficients are the same.

7. The array pickup method capable of steplessly adjusting the pickup direction of claim 6, wherein the performing calculation according to a preset audio gain strategy to obtain a gain coefficient corresponding to the first audio and the second audio comprises:
respectively calculating a first energy function corresponding to the first audio and a second energy function corresponding to the second audio according to an average amplitude function in the audio gain strategy; and
calculating the first energy function and the second energy function according to a gain calculation formula in the audio gain strategy to obtain the gain coefficient corresponding to current audio frames.

8. The array pickup method capable of steplessly adjusting the pickup direction of claim 6, wherein the performing calculation according to a preset audio gain strategy to obtain a gain coefficient corresponding to the first audio and the second audio comprises:
respectively performing short-time Fourier transform on the first audio and the second audio according to a transform calculation formula in the audio gain strategy to obtain a corresponding first frequency domain signal and second frequency domain signal;
respectively calculating a first energy function corresponding to the first frequency domain signal and a second energy function corresponding to the second frequency domain signal according to an average amplitude function in the audio gain strategy; and
calculating the first energy function and the second energy function according to a gain calculation formula in the audio gain strategy to obtain a frequency domain sub-band gain coefficient as the gain coefficient corresponding to current audio frames.

9. An array pickup method capable of steplessly adjusting a pickup direction, wherein the method is applied to a pickup controller and a signal processor, the pickup controller is respectively in communication connection with a directionality adjustable pickup array and the signal processor, the directionality adjustable pickup array consists of a unidirectional mic capsule and a nondirectional mic capsule, the signal processor is in communication connection with an independent nondirectional mic capsule so as to acquire a corresponding independent pickup audio from the independent nondirectional mic capsule, and the method comprises:
if a first audio from the unidirectional mic capsule and a second audio from the nondirectional mic capsule are received, sending the first audio to the signal processor by the pickup controller;
performing calculation by the pickup controller according to a preset audio gain strategy to obtain a gain coefficient corresponding to the first audio and the second audio;
performing gain processing on the first audio by the pickup controller according to the gain coefficient to obtain a corresponding first gain audio, and sending the corresponding first gain audio to the signal processor;
performing delay alignment on the second audio by the pickup controller according to a preset delay duration to obtain a corresponding auxiliary audio;
performing, by the signal processor according to a preset blocking matrix, blocking filtering processing on the first audio and the independent pickup audio collected by the independent nondirectional mic capsule to obtain corresponding blocking audios obtained by removing an original audio in a target direction by blocking;
performing adaptive filtering enhancement on the first gain audio by the signal processor according to a preset filtering enhancement strategy and the blocking audios to obtain a corresponding first filtering audio and filter coefficient, and sending the corresponding first filtering audio and filter coefficient to the pickup controller;
performing sound mixing processing on the first filtering audio and the auxiliary audio by the pickup controller according to a preset proportion value to obtain a corresponding sound-mixed audio; and
performing post-filtering processing on the sound-mixed audio by the pickup controller according to the filter coefficient to obtain a corresponding target audio.

10. An array pickup method capable of steplessly adjusting a pickup direction, wherein the method is applied to a pickup controller and a signal processor, the pickup controller is respectively in communication connection with a composite differential pickup array and the signal processor, the composite differential pickup array consists of a composite pickup mic capsule and a nondirectional mic capsule, the composite pickup mic capsule is symmetrically combined by two nondirectional mic capsules, the signal processor is in communication connection with an independent nondirectional mic capsule so as to acquire a corresponding independent pickup audio from the independent nondirectional mic capsule, and the method comprises:
if a first sub-audio and a second sub-audio that are from the composite pickup mic capsule and a second audio from the nondirectional mic capsule are received, performing audio compositing on the first sub-audio and the second sub-audio by the pickup controller according to a preset directionality adjustment parameter to obtain a corresponding first audio, and sending the corresponding first audio to the signal processor;
performing calculation by the pickup controller according to a preset audio gain strategy to obtain a gain coefficient corresponding to the first audio and the second audio;
performing gain processing on the first audio by the pickup controller according to the gain coefficient to obtain a corresponding first gain audio, and sending the corresponding first gain audio to the signal processor;
performing delay alignment on the second audio by the pickup controller according to a preset delay duration to obtain a corresponding auxiliary audio;
performing, by the signal processor according to a preset blocking matrix, blocking filtering processing on the first audio and the independent pickup audio collected by the independent nondirectional mic capsule to obtain corresponding blocking audios obtained by removing an original audio in a target direction by blocking;
performing adaptive filtering enhancement on the first gain audio by the signal processor according to a preset filtering enhancement strategy and the blocking audios to obtain a corresponding first filtering audio and filter coefficient, and sending the corresponding first filtering audio and filter coefficient to the pickup controller;
performing sound mixing processing on the first filtering audio and the auxiliary audio by the pickup controller according to a preset proportion value to obtain a corresponding sound-mixed audio; and
performing post-filtering processing on the sound-mixed audio by the pickup controller according to the filter coefficient to obtain a corresponding target audio.

11. An array pickup apparatus capable of steplessly adjusting a pickup direction, wherein the apparatus comprises an apparatus body, a pickup controller and a directionality adjustable pickup array, the pickup controller is used for performing the array pickup method capable of steplessly adjusting the pickup direction of claim 1;
the pickup controller is disposed in the apparatus body;
the directionality adjustable pickup array consists of a unidirectional mic capsule and a nondirectional mic capsule; the unidirectional mic capsule and the nondirectional mic capsule are both disposed on the same outer surface of the apparatus body; a pickup direction of the unidirectional mic capsule faces away from the nondirectional mic capsule; and
the pickup controller is respectively in communication connection with the unidirectional mic capsule and the nondirectional mic capsule.

12. The array pickup apparatus capable of steplessly adjusting the pickup direction of claim 11, wherein the apparatus further comprises an independent pickup device, the independent pickup device comprises a signal processor and an independent nondirectional mic capsule that are in communication connection, and the signal processor is in communication connection with the pickup controller;
the apparatus body is provided with a fixing component for fixing the independent pickup device; and during use, the independent pickup device is disassembled from the apparatus device to perform independent pickup and is combined with the apparatus body for use.

13. An array pickup apparatus capable of steplessly adjusting a pickup direction, wherein the apparatus comprises an apparatus body, a pickup controller and a composite differential pickup array, the pickup controller is used for performing the array pickup method capable of steplessly adjusting the pickup direction of claim 5;
the pickup controller is disposed in the apparatus body;
the composite differential pickup array consists of a composite pickup mic capsule and a nondirectional mic capsule, and the composite pickup mic capsule is symmetrically combined by two nondirectional mic capsules; the composite pickup mic capsule and the nondirectional mic capsule are both disposed on the same outer surface of the apparatus body; the three nondirectional mic capsules are arranged on the same straight line, and a distance between the two nondirectional mic capsules in the composite pickup mic capsule is smaller than a distance between the composite pickup mic capsule and the nondirectional mic capsule disposed alone; and
the pickup controller is respectively in communication connection with the three nondirectional mic capsules.

14. The array pickup apparatus capable of steplessly adjusting the pickup direction of claim 13, wherein the apparatus further comprises an independent pickup device, the independent pickup device comprises a signal processor and an independent nondirectional mic capsule that are in communication connection, and the signal processor is in communication connection with the pickup controller;
the apparatus body is provided with a fixing component for fixing the independent pickup device;
and during use, the independent pickup device is disassembled from the apparatus device to perform independent pickup and is combined with the apparatus body for use.
